(19) United States
(12) Patent Application Publication
(10) Pub. No.: US 2021/0246329 A1
(43) Pub. Date: Aug. 12, 2021

(54) WATER-DISPERSIBLE COATING COMPOSITION FOR PAPER MAKING, AND METHOD FOR MANUFACTURING ECO-FRIENDLY TYPE FOOD WRAPPING PAPER WITH IMPROVED DAMP-PROOFING PROPERTIES AND BLOCKING PROPERTIES BY USING SAME

(71) Applicant: REPAPER INC., Seoul (KR)

(72) Inventors: Cheol YOON, Seoul (KR); Sang Il LEE, Seoul (KR)

(21) Appl. No.: 16/972,817

(22) PCT Filed: May 24, 2019
(86) PCT No.: PCT/KR2019/006258

§ 371 Date: Dec. 7, 2020

(30) Foreign Application Priority Data
Jun. 5, 2018 (KR) 10-2018-0065049

(51) Int. Cl. C09D 133/08; C09D 7/61; C09D 7/40; D21H 17/37; D21H 17/68; D21H 21/16; D21H 21/52

(52) U.S. Cl. CPC C09D 133/08; C09D 7/61; C09D 7/69; D21H 21/52; D21H 17/37; D21H 17/68; D21H 21/16; C09D 7/70

(57) ABSTRACT

The present technology relates to a coating composition for paper making and to a method for manufacturing an eco-friendly type food wrapping paper with improved damp-proofing properties and blocking properties by using same. The water-dispersible coating composition for paper making of the present technology is a coating composition for paper making, which comprises an acrylic polymer resin and a pigment, the acrylic polymer resin containing an acrylate, the pigment containing at least one of clay, talc, and calcium carbonate, wherein the pigment has a particle diameter of 1800 nm or smaller, and is blended with the acrylate while the acrylate is used as a binder.

### TECHNICAL FIELD

The present invention relates to a water-dispersible coating composition for papermaking and a method of manufacturing an eco-friendly food wrapping paper with improved moistureproofing and blocking properties using the same, and more specifically, to a water-dispersible coating composition for papermaking, which includes an acrylic polymer resin and a pigment, and a method of manufacturing an eco-friendly food wrapping paper with improved moistureproofing and blocking properties using the same.

### BACKGROUND ART

Paper cups are mainly used as disposable products for carrying food and beverages such as water, coffee, ice cream, salad, and the like. In recent years, due to the explosive growth of the dessert market, the usage of paper cups is increasing exponentially.

Disposable paper cups or containers have environmental pollution issues as the disposable paper cups or containers are very convenient to use.

The disposable paper cups or containers are typically manufactured by coating natural pulp with a coating material such as polyethylene (PE) for storing food and beverages, and it is known that it takes up to 20 years for one discarded paper cup to be decomposed due to the coating material.

Although there is a potential for recycling, the coating material is not aqueous and thus is difficult to recycle. This is because there is an undissociated PE film during a recycled pulp production process. The paper on which the undissociated PE film remains adheres to a roller disposed in a high-temperature process upon recycling, causing process contamination.

To solve the above problem, a water-dispersible coating material such as an acrylic polymer resin may be used as the coating material.

However, the coating material to be applied to paper cups should satisfy the following characteristics. Most basically, oil resistance and water resistance are required. In addition, as characteristics required in the manufacturing process, moldability for forming the lip of the cup, heat sealability for sealing, and bonding between bottom paper and side paper should be satisfied. Furthermore, in the process of storing and distributing base paper for paper cups after mass production, there is also a need for a characteristic in that a blocking problem (a phenomenon in which base paper for paper cups, both surfaces of which have been coated, are pressed and adhered to each other while being placed up and down) upon winding does not occur.

To this end, a pigment is added to the coating material made of an acrylic polymer resin. In this case, clay, talc, calcium carbonate, or the like is used as the pigment.

Such a pigment satisfies the above-required characteristics, and furthermore, talc is known to further satisfy a moistureproofing property (Korean Registered Patent No. 10-1547935, Invention Title: Eco-friendly coating composition for papermaking and method of manufacturing eco-friendly food wrapping paper with moistureproofing property using the same).

However, it is still insufficient to satisfy the required moistureproofing property. In particular, when food and beverages with a large difference in temperature with respect to room temperature are stored, for example, when hot coffee or cold ice cream is carried, it is inevitable that water vapor is formed outside paper cups or containers or permeates them. In addition, high-temperature moisture permeating the paper is condensed to form water even on the surface on which the paper cups or containers are placed, which adversely affects the hygiene and appearance aspect.

To satisfy the required moistureproofing property, according to the very basic moistureproofing mechanism, only a large amount of coating material has to be applied. However, this causes the above-described blocking problem.

The inventors of the present invention have conducted research along with trial and error for a long period of time to solve these problems and completed the present invention.

### DISCLOSURE

### Technical Problem

The present invention is directed to providing a water-dispersible coating composition for papermaking, which includes an acrylic polymer resin and a pigment, and a method of manufacturing an eco-friendly food wrapping paper with improved moistureproofing and blocking properties using the same.

Meanwhile, other objects that are not specified in the present invention will be additionally considered within the range that can be easily deduced from the following detailed description and effects thereof.

### Technical Solution

One aspect of the present invention provides a water-dispersible coating composition for papermaking, which includes an acrylic polymer resin and a pigment, wherein the acrylic polymer resin includes an acrylate, the pigment includes one or more of clay, talc, and calcium carbonate, and the pigment has a particle size of 1,800 nm or less and is blended with the acrylate using the acrylate as a binder.

The pigment may include talc whose particles have a platy shape.

The pigment may have a particle size of 4 nm or more and 1,800 nm or less.

Another aspect of the present invention provides a method of manufacturing an eco-friendly food wrapping paper with improved moistureproofing and blocking properties, which includes: providing a substrate made of paper; and coating the substrate with a water-dispersible coating agent for papermaking to form a coating layer, which includes an acrylic polymer resin and a pigment, wherein the acrylic polymer resin includes an acrylate, the pigment includes one or more of clay, talc, and calcium carbonate, and the pigment has a particle size of 1,800 nm or less and is blended with the acrylate using the acrylate as a binder.

Still another aspect of the present invention provides an eco-friendly food wrapping paper with improved moistureproofing and blocking properties, which includes: a substrate; and a water-dispersible coating agent used for papermaking, which is applied on the substrate and includes an acrylic polymer resin and a pigment, wherein the eco-friendly food wrapping paper satisfies a blocking property of 230° C. or more measured by an ASTM F2029 test method, a moistureproofing property of 78 g/m²/day or less measured by a KS T1305 test method, a water resistance of 2.0 g/m²/₂ min or less measured by a TAPPI T441 test method, an oil resistance of 7 or more measured by a TAPPI T559cm-02 test method, and a pulp yield (recyclability) of 95% or more measured by a TAPPI T275sp-02 Somerville-type test method.

### Advantageous Effects

The present invention can provide a water-dispersible coating composition for papermaking, which is capable of substantially improving a moistureproofing property, and a method of manufacturing an eco-friendly food wrapping paper with improved moistureproofing and blocking properties using the same.

In addition, the present invention can provide food wrapping paper which exhibits an excellent moistureproofing property even when carrying not only hot beverages but also cold food and beverages.

According to the present invention, the printability of a paper surface in a printing process can be further increased.

According to the present invention, the moistureproofing property can be improved, and a blocking problem that may be caused upon winding can also be solved.

According to the present invention, various difficulties in a manufacturing process, which accompany coating, can be solved at one time due to the excellent blendability of a coating material.

According to the present invention, environmental pollution can be reduced upon disposal due to natural degradability.

According to the present invention, since all of the compositions forming a coating layer are originally used as papermaking materials, recycling is very easy.

### DESCRIPTION OF DRAWINGS

FIG. 1 is a cross-sectional view of food wrapping paper coated with a coating agent for papermaking according to an embodiment of the present invention.

FIG. 2 is a flowchart of a method of manufacturing food wrapping paper coated with a coating agent for papermaking over time according to an embodiment of the present invention.

FIG. 3 shows schematic diagrams of nanoscale pigments according to embodiments of the present invention, FIG. 3A shows plate-shaped nanoscale talc, FIG. 3B shows nanoscale calcium carbonate, and FIG. 3C shows nanoscale clay.

The accompanying drawings are exemplified as reference for understanding the technical spirit of the present invention, and the scope of the present invention is not limited thereto.

### MODES OF THE INVENTION

Hereinafter, the most exemplary embodiments of the present invention will be described. In the accompanying drawings, thickness and spacing are expressed for convenience of description and may be exaggerated compared to actual physical thickness. In describing the present invention, known configurations irrelevant to the gist of the present invention may be omitted. In adding reference numerals to elements of each drawing, it should be noted that the same elements have the same number as much as possible, even if they are indicated on different drawings.

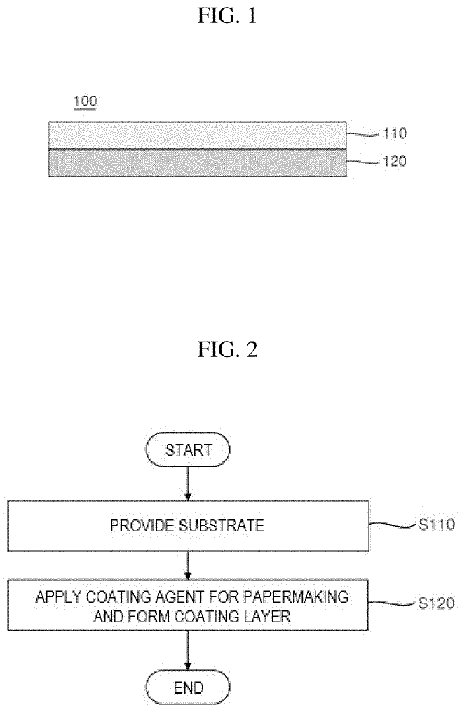

FIG. 1 is a cross-sectional view of food wrapping paper 100 coated with a water-dispersible coating agent for papermaking according to an embodiment of the present invention.

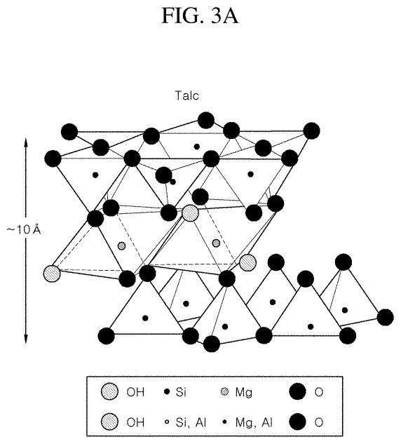

FIG. 2 is a flowchart of a method of manufacturing the food wrapping paper 100 coated with a water-dispersible coating agent for papermaking over time according to an embodiment of the present invention.

As shown in FIGS. 1 and 2, the food wrapping paper 100 coated with a coating agent for papermaking (hereinafter, referred to as “food wrapping paper” for convenience of description) according to the embodiment of the present invention includes a substrate 110 and a coating agent 120.

A substrate 110 is provided (S110), and then a coating layer 120 is formed by coating the substrate with a coating agent for papermaking (S120), thereby manufacturing the food wrapping paper 100.

The substrate 110 is made of paper. The substrate may be coated paper, uncoated paper, kraft paper, or the like.

In the present invention, for convenience of description, it is assumed that the substrate 110 is uncoated paper. The uncoated paper is paper that has not been coated with chemicals, fine stone powder, or the like.

In order to be applied as the food wrapping paper, the uncoated paper is preferably made of raw materials that are harmless to food when in contact with food.

According to an embodiment of the present invention, the uncoated paper may have a basis weight of 100 to 350 g/m².

The coating layer 120 is disposed on the substrate 110. The coating layer 120 is formed by coating the substrate with a water-dispersible coating agent for papermaking.

The water-dispersible coating agent for papermaking (hereinafter, referred to as a “coating agent” for convenience of description) according to the embodiment of the present invention includes an acrylic polymer resin and a pigment. That is, the coating agent is a mixed coating agent of an acrylic polymer resin and a pigment.

The coating layer 120 is intended to improve moistureproofing and blocking properties, and the mixed coating agent may be applied in an amount of 10 to 40 g/m² based on solid content.

When the coating amount of the mixed coating agent is less than 10 g/m², the exhibition of moistureproofing performance is degraded, and when the coating amount is more than 40 g/m², a blocking problem occurs.

According to an embodiment of the present invention, the acrylic polymer resin may be a pure acrylic polymer resin obtained by polymerizing acrylic monomers until an average molecular weight reaches 500 to 1,000,000.

Specifically, the acrylic polymer resin is water-dispersible and may minimize problems (e.g., contamination of process water, adsorption of a drying drum, stoppage of a papermaking wire, and the like) that may occur during a repulping process and a papermaking process which are processes for recycling in a typical papermaking process.

In addition, the acrylic polymer resin is suitable because it has long been used as a binder for an inorganic pigment in the paper industry.

Additionally, a coating layer formed including the acrylic polymer resin has excellent water resistance and oil resistance.

The acrylic polymer resin may be an aqueous solution with a concentration of 30 to 55 wt % for application to a papermaking coater or the like. The concentration may be adjusted to realize a desired coating amount according to various types of coating equipment and operating conditions, but the above-described concentration range is suitable for actual coating because the range is obtained through repetitive experiments.

As the coating equipment for coating, both an on-machine coater and an off-machine coater, which are typically used in the paper industry, may be used. Also, any one selected from among a roll coater, a blade coater, a rod coater, an air knife coater, a short dwell coater capable of effectively controlling a low coating amount, a bill blade coater, and a gate roll coater may be used. In addition, the same coating effect may be obtained even using gravure-type printing equipment.

According to an embodiment of the present invention, the pigment may include one or more of clay, talc, and calcium carbonate. The pigment may have a particle size of 4 nm to 1,800 nm as described below.

A pigment commonly used for internal addition or external coating in the paper industry typically has a particle size of 4 μm to 20 μm and may be subjected to milling to obtain a pigment with a desired particle size. The commercialized size of the pigment ranges from about 400 to 1,000 nm, and the pigment may be subjected to milling once more to relatively easily obtain a smaller size (e.g., about 180 nm) thereof.

Such a nanoscale pigment basically serves to fill the porous portion of the substrate.

In the present invention, a particle size may be an average particle size.

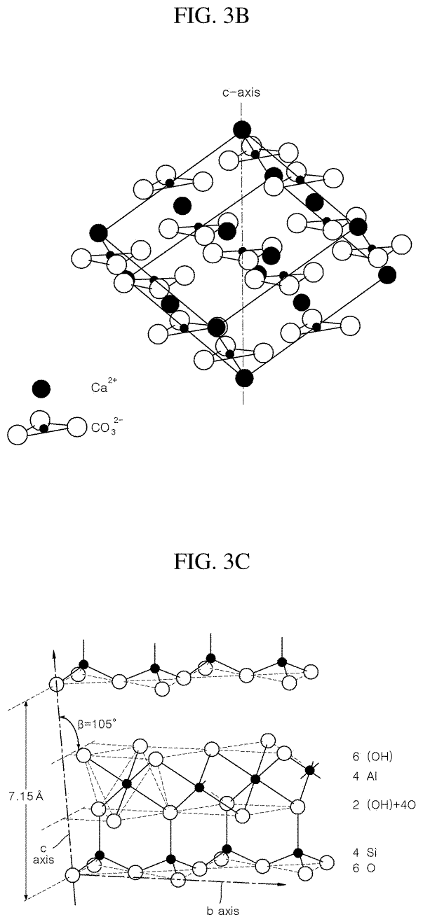

FIG. 3 show schematic diagrams of nanoscale pigments according to embodiments of the present invention, FIG. 3A shows plate-shaped nanoscale talc, FIG. 3B shows nanoscale calcium carbonate, and FIG. 3C shows nanoscale clay. Hereinafter, the pigments will be described in more detail with reference to FIG. 3.

First, referring to FIG. 3A, talc is generally a mineral represented by Mg₃Si₄O₁₀(OH)₂ and may have a particle size of 4 nm to 1,800 nm and a platy shape.

Talc is an inorganic pigment with hydrophobicity, unlike inorganic pigments with hydrophilicity such as calcium carbonate, and is suitable for exhibiting moistureproofing performance and water resistance. Also, talc has been widely used as a coating pigment for enhancing printability in the paper industry and is thus easy to obtain.

When the particle size of talc is less than 4 nm, it is not possible to realize necessary barrier properties such as a moistureproofing property and the like. Also, to obtain talc having a particle size of less than 4 nm, very high processing costs are required, so it is not economical.

When the particle size of talc is more than 1,800 nm, the moistureproofing effect according to an increase in coating amount is not substantially increased. Also, when the particle size is more than 1,800 nm, talc is not blended with the acrylic polymer resin which is a binder. When the blending does not smoothly proceed, the paper surface is not uniformly covered when coated, or the dispersion stability of a coating liquid is degraded over time, leading to agglomeration between talc particles and accordingly precipitation. Therefore, the talc according to the embodiment of the present invention preferably has a particle size of 4 nm to 1,800 nm. More preferably, talc having a particle size of 180 nm to 400 nm may be selected to increase economic efficiency.

Talc is applied in a mixed state with a binder, and, as the binder, the above-described acrylic polymer resin is used. Talc and the binder may be mixed in a weight ratio of 10:90 to 50:50 based on solid content. This ratio may be determined according to purpose and operating conditions.

Next, referring to FIG. 3B, calcium carbonate is a mineral represented by CaCO₃ and may have a particle size of 4 nm to 1,800 nm. Unlike the above-described nanoscale talc, calcium carbonate does not have a platy shape even when downsized to the nanoscale through dry or wet grinding. Such a physical structure is somewhat disadvantageous in terms of barrier properties such as a moistureproofing property compared to nanoscale talc.

When the particle size of calcium carbonate is less than 4 nm, it is not possible to realize necessary barrier properties such as a moistureproofing property and the like. Also, to obtain calcium carbonate having a particle size of less than 4 nm, very high processing costs are required, so it is not economical.

When the particle size of calcium carbonate is more than 1,800 nm, it may be difficult to uniformly blend calcium carbonate with a binder and to realize an expected level of the moistureproofing property in coating.

Calcium carbonate is an inorganic pigment with hydrophilicity. Unlike the above-described talc, calcium carbonate has hydrophilicity, and thus the moistureproofing property and water resistance thereof may fall short of those of talc. However, according to a typical physical mechanism for exhibiting the moistureproofing property, when a coating pigment is applied with a sufficiently large thickness, the moistureproofing effect thereof is exhibited, and therefore, calcium carbonate is good enough to be used as a coating pigment in the mixed coating agent according to an embodiment of the present invention. In addition, calcium carbonate has been widely used as a pigment for coating a paper surface in the paper industry and is thus easy to obtain.

Calcium carbonate is applied in a mixed state with a binder, and, as the binder, the above-described acrylic polymer resin is used. Calcium carbonate and the binder may be mixed in a weight ratio of 10:90 to 60:40 based on solid content. This ratio may be determined according to purpose and operating conditions.

Next, referring to FIG. 3C, clay is an inorganic filler with hydrophilicity and may have a particle size of 4 nm to 1,800 nm. Clay commonly used in the paper industry is represented by Al₄Si₄O₁₀(OH)₈. Like the above-described calcium carbonate, clay dose also not have a platy shape even when downsized to the nanoscale unlike talc, and such a physical structure is disadvantageous in terms of barrier properties such as a moistureproofing property compared to nanoscale talc.

When the particle size of clay is less than 4 nm, it is not possible to realize necessary barrier properties such as a moistureproofing property and the like. Also, to obtain clay having a particle size of less than 4 nm, very high processing costs are required, so it is not economical.

When the particle size of clay is more than 1,800 nm, it may be difficult to uniformly blend clay with a binder and to realize an expected level of the moistureproofing property in coating.

Like calcium carbonate, clay is an inorganic pigment with hydrophilicity. Unlike the above-described talc, clay has hydrophilicity, and thus the moistureproofing property and water resistance thereof may fall short of those of talc. However, according to a typical physical mechanism for exhibiting a moistureproofing property, when a coating pigment is applied with a sufficiently large thickness, the moistureproofing effect thereof is exhibited, and therefore, clay is good enough to be used as a coating pigment in the mixed coating agent according to an embodiment of the present invention. In addition, clay has been widely used as a pigment for coating a paper surface in the paper industry and is thus easy to obtain.

Clay is applied in a mixed state with a binder, and, as the binder, the above-described acrylic polymer resin is used. Clay and the binder may be mixed in a weight ratio of 10:90 to 60:40 based on solid content. This ratio may be determined according to purpose and operating conditions. However, as the concentration percentage of the pigment increases, the viscosity of the blended coating mixture rapidly increases compared to the above-described talc or calcium carbonate, which may be disadvantageous in terms of coatability. Therefore, it is necessary to carefully perform mixing according to individual characteristics of the papermaking process.

In addition, according to an embodiment of the present invention, a mixture of two or more of talc, calcium carbonate, and clay may be used. In this case, the particle size of the individual pigments preferably satisfies a range of 4 nm to 1,800 nm.

Talc and calcium carbonate may be mixed in a weight ratio of 40:60 to 90:10.

Talc and clay may be mixed in a weight ratio of 40:60 to 90:10.

Calcium carbonate and clay may be mixed in a weight ratio of 50:50 to 90:10.

When talc and calcium carbonate are mixed, it is advantageous in terms of costs, as compared to when a coating composition is composed of talc alone, because calcium carbonate having a relatively low cost contributes to providing the same barrier performance effect.

When talc and clay are mixed, it is advantageous in terms of sensibility, that is, the feeling of relatively softness of the surface, as compared to when a coating composition is composed of talc alone. In addition, as the mixing percentage of clay increases, the printability of a paper surface in a typical printing process is improved, as compared to the coating composition composed of talc alone.

When calcium carbonate and clay are mixed, barrier properties may be inferior to a coating composition composed of talc alone, but it is advantageous in terms of costs. In addition, ink receptivity in a typical printing process is better than that of the coating composition composed of talc alone, and thus it is advantageous in terms of printing quality.

Meanwhile, after the formation of a coating layer (S120), drying the coating layer may be further performed.

The temperature condition required for drying the coating layer is in the range of 105 to 150° C., and preferably, 120 to 135° C. When the temperature is less than 105° C., a coating film made of the acrylic polymer resin is not completely formed, making it difficult to realize desired performance, and talc, which is an inorganic pigment, is insufficiently adhered, resulting in peeling. In addition, the blocking problem of an incomplete coating film that has not been completely dried may occur. When the temperature is more than 150° C., the degree of curing of the acrylic polymer resin and the binder is increased, and thus paper flexibility is degraded, and releasability is increased, resulting in a very slippery surface. Therefore, the optimum drying conditions may be set within the above-described temperature range in consideration of the drying capacity and time of production equipment.

In addition, after the drying process, calendering may be further performed to make the coated paper firmer and to improve surface smoothness. Through the calendering process, the pores of the paper are further reduced, and the density of the coating layer is increased. Therefore, the calendering process is effective in improving a moistureproofing property.

According to the embodiment of the present invention, it is possible to substantially improve moistureproofing properties and simultaneously solve the blocking problem. In addition, food wrapping paper having an excellent moistureproofing property even when carrying not only hot beverages but also cold food and beverages may be provided. Additionally, the printability of a paper surface in a printing process is improved.

In addition, according to the embodiment of the present invention, various difficulties in a manufacturing process, which accompany coating, may be solved due to the excellent blendability of the coating composition for papermaking.

Additionally, according to the embodiment of the present invention, since all of the coating compositions for papermaking are originally used as papermaking materials, it is favorable for recycling the paper as a raw material. In addition, even when the coating composition itself is disposed, there is no concern about environmental pollution due to natural degradability.

Hereinafter, the present invention will be described in detail with reference to the preparation examples, examples, and comparative examples. The following preparation examples, examples, and comparative examples are merely presented to exemplify the present invention, and the scope of the present invention is not limited to the following preparation examples, examples, and comparative examples.

### Preparation Example

An acrylic polymer resin mainly composed of an acrylate was used as a binder for an inorganic pigment of a mixed coating agent. A pigment and the acrylic polymer resin were dispersively mixed in a weight ratio of 50:50 based on solid content to prepare a mixed coating agent. As described below, an example using talc is Example 1, an example using calcium carbonate is Example 2, and an example using clay is Example 3.

### Example 1

As uncoated paper, 190 g/m² of cup paper for food wrapping (commercially available from MOORIM PAPER) was used, and the uncoated paper was coated with the coating agent prepared in Preparation Example through rod coating in a typical papermaking coater.

The total coating amount of the water-dispersible mixed coating agent including the acrylic polymer resin used as a binder was 16 g/m² based on dry solid content.

The amount of talc coated in the coating process was 8 g/m² based on dry solid content. The particle size of the used talc was 400 nm, which was the commercialized size, and thus the talc was easy to obtain.

Additionally, calendering was performed to make the surface smooth.

### Example 2

The same uncoated paper as in Example 1 was used.

The total coating amount of the water-dispersible mixed coating agent including the acrylic polymer resin used as a binder was 16 g/m² based on dry solid content.

The amount of calcium carbonate coated in the coating process was 8 g/m² based on dry solid content. The particle size of the used calcium carbonate was 400 nm.

Additionally, calendering was performed to make the surface smooth.

### Example 3

The same uncoated paper as in Example 1 was used.

The total coating amount of the water-dispersible mixed coating agent including the acrylic polymer resin used as a binder was 16 g/m² based on dry solid content.

The amount of clay coated in the coating process was 8 g/m² based on dry solid content. The particle size of the used clay was 400 nm.

Additionally, calendering was performed to make the surface smooth.

### Comparative Example 1

A polyethylene-coated fabric (205 g/m²) for making a commercial 6.5-ounce paper cup was purchased and used as Comparative Example 1.

### Comparative Example 2

Among layer wrapping papers commonly available on the market, a wrapping paper in which multi-layered polyethylene and polypropylene are bonded to an aluminum foil (thickness 7 μm) was used as Comparative Example 2.

Since aluminum is one of the materials having an excellent moistureproofing property, it was used in this comparative example.

### Test Example

Material properties of the samples manufactured in Examples and Comparative Examples were tested under the same conditions, and results thereof are summarized in Table 1.

TABLE 1

| | Measurement | | | | Comparative | Comparative |
|---|---|---|---|---|---|---|
| Items | standard | Example 1 | Example 2 | Example 3 | Example 1 | Example 2 |
| Blocking | ASTM | 240° C. | 230° C. | 230° C. | 200° C. | 190° C. |
| properties | F2029 | | | | | |
| Moistureproofing | KS T1305 | 30 | 65 | 50 | 95 | 10 |
| property | (g/m²/day) | | | | | |
| (moisture | | | | | | |
| permeability) | | | | | | |
| Water resistance | TAPPI | 0.5 | 1.2 | 1.2 | 2.0 | 0.5 |
| | T441 | | | | | |
| | (g/m²/2 min) | | | | | |
| Oil resistance | TAPPI | 11 | 11 | 10 | 5 | 11 |
| | T559cm-02 | | | | | |
| Recyclability | TAPPI | 99% | 99% | 99% | 40% | Unavailable |
| | T275sp-02 | | | | | |
| | acceptance | | | | | |
| | ratio | | | | | |
| Food safety | Codex of | Suitable | Suitable | Suitable | Suitable | Suitable |
| | Ministry of | | | | | |
| | Food and | | | | | |
| | Drug Safety | | | | | |
| | for food | | | | | |
| | utensil and | | | | | |
| | container | | | | | |
| | wrapping | | | | | |

The blocking properties of the food wrapping papers manufactured in Examples of the present invention were tested in accordance with ASTM F2029 using a heat sealer (Model name: HSM-4, commercially available from RDM Test Equipment). When the resulting value was 180° C. or more, it was judged that there was no problem in mass production in the typical papermaking process and converting process due to no occurrence of a blocking problem. Examples satisfied this standard. Therefore, even when both surfaces of a substrate were coated, storage may be easy after winding, and a phenomenon in which the wrapping papers placed up and down adhere to each other may be prevented even during long-term storage. The moistureproofing properties of the food wrapping papers manufactured in Examples of the present invention were tested in accordance with Korean Industrial Standards (KS T1305), and Examples exhibited a moistureproofing property in the range of 30 to 65 g/m²/day. In this case, a higher moistureproofing property value indicates that a larger amount of moisture permeates, and therefore, the moistureproofing property may also be referred to as moisture permeability. In addition, water resistance was evaluated by a Cobb sizing test of TAPPI T441, and water resistance values of 1.2 g/m²/₂ min or less were exhibited. This means that the food wrapping papers have an excellent moistureproofing property and excellent water resistance.

In addition, the oil resistance of the food wrapping papers manufactured in Examples of the present invention was tested in accordance with TAPPI T559cm-02, and oil resistances of #10 or more were exhibited. This means that the food wrapping papers exhibit excellent oil resistance.

Additionally, the eco-friendliness of the food wrapping papers manufactured in Examples of the present invention was tested by measuring the acceptance ratio of the raw material usable as a raw material of paper by the Somerville screening method of U.S. Technical Association of the Pulp and Paper Industry (TAPPI), and as a result, repulpability of 99% or more was confirmed. According to the alkali dissociation and dispersion test in accordance with the Korean Ministry of Environment's Environmental Labeling Target Product and Certification Standard (EL606), the dried pulp did not include impurities, such as rubber, synthetic resin lumps, and the like, other than pulp and did not exhibit tackiness. Therefore, the food wrapping papers achieved the level of reusability as a raw material of paper.

In addition, it can be confirmed that the food wrapping papers manufactured in Examples of the present invention satisfied the test specification of a processed material in the Codex of the Ministry of Food and Drug Safety for food utensil and container wrapping and thus can be safely used as a food wrapping paper.

### Additional Test Examples

Additional test examples described below show a change in the moistureproofing property (moisture permeability) according to the particle size of talc.

The additional test examples were set under all the same conditions excluding the particle size of talc so as to be compared to Example 1. That is, the same uncoated paper as in Example 1 was used, the total coating amount of the water-dispersible mixed coating agent including the acrylic polymer resin used as a binder was 16 g/m² based on dry solid content, and the amount of talc coated in the coating process was 8 g/m² based on dry solid content.

TABLE 2

| | | Moistureproofing | | |
|---|---|---|---|---|
| | Particle | property (moisture | Water | Oil |
| | size | permeability) | resistance | resistance |
| Classification | (nm) | (g/m²/day) | (g/m²/2 min) | (#) |
| Example a | 4 | 15 | 0.4 | 12 |
| Example b | 10 | 20 | 0.4 | 12 |
| Example c | 50 | 20 | 0.4 | 11 |
| Example d | 100 | 30 | 0.5 | 11 |
| Example e | 500 | 45 | 0.5 | 11 |
| Example f | 700 | 48 | 0.7 | 11 |
| Example g | 1200 | 53 | 1.0 | 10 |
| Example h | 1600 | 55 | 1.2 | 10 |
| Example i | 1800 | 60 | 1.2 | 9 |
| Comparative | 2000 | 440 | 20 | 6 |
| Example a | | | | |
| Comparative | 2200 | 630 | 26 | 5 |
| Example b | | | | |
| Comparative | 2500 | 800 | 30 | 5 |
| Example c | | | | |

As can be seen in Table 2, as the particle size of talc increases, moisture permeability increases. The moisture permeability increases slowly as the particle size increases from 4 nm to 1,800 nm (Examples a to i), but the moisture permeability increases rapidly when the particle size reaches a certain point of 2,000 nm (Comparative Examples a to c). It is determined that this is because talc may no longer effectively block water vapor passing through the pores due to an increase in the gap between pigment particles in the coating film and may also not fill the porous portion of the substrate. That is, when the particle size of talc is 2 μm or more, the function of the coating film formed of the mixed coating agent to effectively block water vapor is substantially degraded. On the other hand, when the particle size of talc is set to 1,800 nm or less, it can be seen that a desired moistureproofing property of 65 g/m²/day or less, as measured by the KS T1305 test method, may be obtained.

Meanwhile, other evaluation items of the test examples (Examples a to i and Comparative Examples a to c) were measured, and as the particle size increases, water resistance and oil resistance also tend to increase similarly to the moisture permeability. These results also are due to an increase in barrier properties of the mixed coating film, and an inability to physically densely fill the pores of the substrate upon coating. That is, each of water resistance and oil resistance was maintained at a similar level as the particle size increases from 4 nm to 1,800 nm, but the values thereof are changed rapidly when the particle size reaches 2,000 nm. In the case of a particle size of 2,000 nm or more, water resistance ranges from 20 to 30 g/m²/₂ min, and oil resistance is lowered to 6 or less.

Additional test examples described below show a change in the moistureproofing property (moisture permeability) according to the particle size of calcium carbonate and clay. Table 3 shows data for calcium carbonate, and Table 4 shows data for clay (Kaolin).

First, looking at Table 3, the test examples shown in Table 3 were set under all the same conditions excluding the particle size so as to be compared to Example 2. That is, the uncoated paper, the coating amount of a coating agent, and the amount of coated calcium carbonate are the same as in Example 2.

TABLE 3

| | | Moistureproofing | | |
|---|---|---|---|---|
| | Particle | property (moisture | Water | Oil |
| | size | permeability) | resistance | resistance |
| Classification | (nm) | (g/m²/day) | (g/m²/2 min) | (#) |
| Example j | 4 | 32 | 0.5 | 12 |
| Example k | 10 | 39 | 0.8 | 12 |
| Example l | 50 | 40 | 1.1 | 12 |
| Example m | 100 | 51 | 1.2 | 11 |
| Example n | 500 | 68 | 1.2 | 11 |
| Example o | 700 | 71 | 1.3 | 10 |
| Example p | 1200 | 74 | 1.7 | 8 |
| Example q | 1600 | 76 | 1.8 | 7 |
| Example r | 1800 | 78 | 2.0 | 7 |
| Comparative | 2000 | 480 | 22 | 5 |
| Example d | | | | |
| Comparative | 2200 | 690 | 29 | 5 |
| Example e | | | | |
| Comparative | 2500 | 880 | 35 | 4 |
| Example f | | | | |

As can be seen in Table 3, as the particle size of calcium carbonate increases, moisture permeability increases. The moisture permeability increases slowly as the particle size increases from 4 nm to 1,800 nm (Examples j to r), but the moisture permeability increases rapidly when the particle size reaches a certain point of 2,000 nm (Comparative Examples d to f). Like the talc mechanism described above for Table 2, it is determined that this is because calcium carbonate may no longer effectively block water vapor passing through the pores due to an increase in the gap between pigment particles in the coating film and may also not fill the porous portion of the substrate. That is, when the particle size of calcium carbonate is 2 μm or more, the function of the coating film formed of the mixed coating agent to effectively block water vapor is substantially degraded. On the other hand, when the particle size of calcium carbonate is set to 1,800 nm or less, it can be seen that a desired moistureproofing property of 78 g/m²/day or less, as measured by the KS T1305 test method, may be obtained. Meanwhile, other evaluation items of the test examples (Examples j to r and Comparative Examples d to f) also tend to increase similarly to the moisture permeability. These results also are due to an increase in the barrier properties of the mixed coating film, and an inability to physically densely fill the pores of the substrate upon coating. That is, each of water resistance and oil resistance was maintained at a similar level as the particle size increases from 4 nm to 1,800 nm, but the values thereof are changed rapidly when the particle size reaches 2,000 nm. In the case of a particle size of 2,000 nm or more, water resistance ranges from 22 to 35 g/m²/₂ min, and oil resistance is lowered to 5 or less.

Next, looking at Table 4, the test examples shown in Table 4 were set under all the same conditions excluding the particle size so as to be compared to Example 3. That is, the uncoated paper, the coating amount of a coating agent, and the amount of coated clay are the same as in Example 3.

TABLE 4

| | | Moistureproofing | | |
|---|---|---|---|---|
| | Particle | property (moisture | Water | Oil |
| | size | permeability) | resistance | resistance |
| Classification | (nm) | (g/m²/day) | (g/m²/2 min) | (#) |
| Example s | 4 | 27 | 0.5 | 12 |
| Example t | 10 | 33 | 0.8 | 11 |
| Example u | 50 | 41 | 1.0 | 11 |
| Example v | 100 | 45 | 1.1 | 10 |
| Example w | 500 | 50 | 1.2 | 10 |
| Example x | 700 | 58 | 0.2 | 10 |
| Example y | 1200 | 61 | 1.5 | 9 |
| Example z | 1600 | 65 | 1.7 | 9 |
| Example aa | 1800 | 69 | 1.8 | 8 |
| Comparative | 2000 | 460 | 21 | 6 |
| Example g | | | | |
| Comparative | 2200 | 660 | 27 | 5 |
| Example h | | | | |
| Comparative | 2500 | 820 | 34 | 4 |
| Example i | | | | |

As can be seen in Table 4, as the particle size of clay increases, moisture permeability increases. The moisture permeability increases slowly as the particle size increases from 4 nm to 1,800 nm (Examples s to aa), but the moisture permeability increases rapidly when the particle size reaches a certain point of 2,000 nm (Comparative Examples g to i). Like the talc mechanism described above for Table 2, it is determined that this is because clay may no longer effectively block water vapor passing through the pores due to an increase in the gap between pigment particles in the coating film and may also not fill the porous portion of the substrate. That is, when the particle size of clay is 2 μm or more, the function of the coating film formed of the mixed coating agent to effectively block water vapor is substantially degraded. On the other hand, when the particle size of clay is set to 1,800 nm or less, it can be seen that a desired moistureproofing property of 69 g/m²/day or less, as measured by the KS T1305 test method, may be obtained. Meanwhile, other evaluation items of the test examples (Examples s to aa and Comparative Examples g to i) also tend to increase similarly to the moisture permeability. These results also are due to an increase in the barrier properties of the mixed coating film, and an inability to physically densely fill the pores of the substrate upon coating. That is, each of water resistance and oil resistance was maintained at a similar level as the particle size increases from 4 nm to 1,800 nm, but the values thereof are changed rapidly when the particle size reaches 2,000 nm. In the case of a particle size of 2,000 nm or more, water resistance ranges from 21 to 34 g/m²/₂ min, and oil resistance is lowered to 6 or less.

As described above, according to the embodiment of the present invention, an eco-friendly food wrapping paper which is capable of substantially improving a moistureproofing property and simultaneously solving a blocking problem can be provided.

Although the technical spirit of the present invention has been specifically recorded according to the above exemplary embodiments, it should be noted that the above embodiments are for the purpose of explanation and not for the limitation thereof. In addition, those of ordinary skill in the technical field of the present invention will understand that various embodiments can be made within the technical spirit of the present invention.

### LIST OF REFERENCE NUMERALS

100: food wrapping paper coated with coating agent for papermaking

110: substrate

120: coating agent

1. A water-dispersible coating composition for papermaking, comprising an acrylic polymer resin and a pigment,
wherein the acrylic polymer resin includes an acrylate,
the pigment includes one or more of clay, talc, and calcium carbonate, and
the pigment has a particle size of 1,800 nm or less and is blended with the acrylate using the acrylate as a binder.

2. The coating composition of claim 1, wherein the pigment includes talc whose particles have a platy shape.

3. The coating composition of claim 1, wherein the pigment has a particle size of 4 nm or more and 1,800 nm or less.

4. A method of manufacturing a water-dispersible coating agent and an eco-friendly food wrapping paper coated with the water-dispersible coating agent and having improved moistureproofing and blocking properties, the method comprising:
providing a substrate made of paper; and
coating the substrate with a water-dispersible coating agent for papermaking, which includes an acrylic polymer resin and a pigment, to form a coating layer,
wherein the acrylic polymer resin includes an acrylate,
the pigment includes one or more of clay, talc, and calcium carbonate, and
the pigment has a particle size of 1,800 nm or less and is blended with the acrylate using the acrylate as a binder.

5. An eco-friendly food wrapping paper with improved moistureproofing and blocking properties, comprising:
a substrate; and
a water-dispersible coating agent used for papermaking, which is applied on the substrate and includes an acrylic polymer resin and a pigment,
wherein the eco-friendly food wrapping paper satisfies a blocking property of 230° C. or more measured by an ASTM F2029 test method, a moistureproofing property of 78 g/m²/day or less measured by a KS T1305 test method, a water resistance of 2.0 g/m²/2 min or less measured by a TAPPI T441 test method, an oil resistance of 7 or more measured by a TAPPI T559cm-02 test method, and a pulp yield (recyclability) of 95% or more measured by a TAPPI T275sp-02 Somerville-type test method.
